(19) United States
(12) Patent Application Publication
(10) Pub. No.: US 2014/0368643 A1
(43) Pub. Date: Dec. 18, 2014

(54) SYSTEMS AND METHODS FOR MONITORING AND TRACKING EMERGENCY EVENTS WITHIN A DEFINED AREA

(71) Applicant: Prevvio IP Holding LLC, Juno Beach, FL (US)

(72) Inventors: Steven E. Siegel, Juno Beach, FL (US); Mark N. Metz, Weston, FL (US)

(21) Appl. No.: 13/916,339

(22) Filed: Jun. 12, 2013

(51) Int. Cl. G08B 13/196

(52) U.S. Cl. CPC G08B 13/19695
USPC 348/143

(57) ABSTRACT

The present invention provides a system, methods, and apparatus to provide surveillance, security, alerting, and tracking functionality. The security system comprises the necessary hardware and software to provide surveillance of a pre-determined area, using a central processing facility located off site to allow for an independent monitoring, information gathering, and decision making component. Such information is collected and the data can be converted into a tactical map. The tactical map includes useful information which can be supplied to responders in an easy to view and understand format.

### FIELD OF THE INVENTION

The present invention relates to security and surveillance; to systems, methods, and apparatus for transmitting, communicating, and tracking emergency events within a predetermined area; and more particularly, to systems, methods, apparatus for transmitting, communicating, and tracking emergency events using physiological measurements and mapping techniques to provide a relatively non-intrusive, real time surveillance system which can be used to secure a pre-determined area, and provide valuable information to first responders during an emergency event occurring within the pre-determined area.

### BACKGROUND OF THE INVENTION

Violent attacks in which individual(s) use weapons with the intention to kill or hurt large numbers of individuals within a public space seem to be occurring with greater frequency. Such attacks are hard to prevent, particularly in open, democratic societies where individuals enjoy freedom to move about without heavy government interference. While open societies provide opportunities for individuals to go about their daily lives without government restrictions, such freedom does have potential drawbacks. One such drawback is the difficulty in preventing emergency events such as the mass shootings seen on college campuses, at a movie theater, or on a primary school campus. While nearly all societies, whether democratic or not, provide some type of law enforcement, it remains nearly impossible to prevent the occurrence of these emergency events. First, it can be too costly to provide enough law enforcement officers to cover every aspect of society. Second, even if was possible to do so, such heavy police force could be seen as a threat to the existence of an open society. In societies like the United States which allow for citizens to possess and carry firearms, it can be very difficult to track individuals who own such weapons or remove them completely. More importantly, mass shootings are generally not carried out by the average law abiding citizen. As such, removing weapons from citizens and/or strong government tracking or interference is seen as impermissible. As such, society remains susceptible to the occurrence of these mass shooting within public places.

The mass killings in the Colorado movie theater or Connecticut elementary school indicate the difficulty societies have in preventing these types of tragedies. To prevent such tragedies, businesses or governments would have to impose costly and intrusive measures, including searching patrons or citizens as they enter their establishments or public spaces. Such actions are contrary to the openness afforded to individuals, and therefore are not always a viable option. Police response usually occurs well after the emergency event starts. More importantly, despite police intervention, it can be difficult to sort out what is occurring during the events and who is the actual perpetrator.

Systems for protecting public spaces generally rely on two mechanisms. The first mechanism is physical in nature, and includes the use of defensive structures such as fencing, walls, or barbed wiring. These structures are designed to prevent an unwanted individual from entering the area and causing an emergency event. Besides being costly, the use of these types of structures can create an environment that seems more like a prison than a business. Use of such structures in other predetermined areas such as school campuses creates less of an ideal learning environment. In addition to the physical structures, many areas are secured using cameras and/or human security personnel. Cameras are generally used after the fact to confirm or attempt to piece together the entire event as it happened. Even if the emergency event is occurring while the responders arrive at the scene, the information received by the responders may not be useful in helping determine the exact location of the perpetrator as he/she moves throughout the area. While the physical structures and human or video surveillance is helpful, it does not eliminate the situation where the perpetrator is a person who belongs in the area.

### DESCRIPTION OF THE PRIOR ART

Numerous systems and devices have been developed to provide surveillance. For example, U.S. Patent Publication Number 2013/0057696 is described as disclosing an exemplary method which includes a mobile user device subsystem for 1) acquiring, during operation in a normal surveillance mode, a first set of surveillance data, 2) transmitting, during operation in the normal surveillance mode, the first set of surveillance data to a server subsystem, 3) detecting, during operation in the normal surveillance mode, a trigger event, 4) transitioning, in response to the detecting of the trigger event, from operation in the normal surveillance mode to operation in an enhanced surveillance mode, 5) acquiring, during operation in the enhanced surveillance mode, a second set of surveillance data; and 6) transmitting, during operation in the enhanced surveillance mode, the second set of surveillance data to the server.

U.S. Pat. No. 8,013,734 is described as disclosing a method of alarm notification. An alert mode of a mobile device is activated based on an emergency situation in an area. The mobile device transmits an indication of the emergency situation to a communication network control system. The communication network control system confirms the indication of the emergency situation to the mobile device and notifies emergency personnel of the indication of the emergency situation. The communication network control system transmits an indication of the emergency situation to one or more additional mobile devices in the area.

U.S. Pat. No. 7,999,847 is described as disclosing an audio surveillance, storage and alerting system, including the following components: one or more audio sensory devices to capture audio data having attribute data representing importance of the audio sensory devices, one or more audio analytics devices to process the audio data to detect audio events. A network management module monitors network status of the audio sensory devices and generates network events reflective of the network status of all subsystems. A correlation engine correlates two or more events weighted by the attribute data of the device used to capture the data. Finally, an alerting engine generates one or more alerts and performs one or more actions based on the correlation performed by the correlation engine. The patent does disclose the use of maps. These maps, however, are maps of the particular network as monitored and do not correlate data received from data collection devices within the system into usable information therein.

U.S. Patent Application Publication Number 2011/0130112 is described as disclosing a system for alerting emergency responders to the existence of an emergency situation. The system includes multiple mobile devices in communication with a mobile communications network. Each mobile device includes an encapsulator for capturing encapsulation data from one or more data sensors of the mobile device. Each mobile device can be placed into an alert mode by a user of the mobile device. An emergency database in communication with the mobile communications network and one or more emergency response dispatchers receives, from one or more mobile devices in the alert mode, the encapsulation data, in substantially real-time. The emergency database sends an emergency alert notification to one or more alert groups associated with the users of each mobile device in alert mode. Each mobile device sends an emergency alert notification to one or more additional mobile devices in a predetermined physical proximity to the mobile device.

U.S. Publication Number 2008/0033252 is described as disclosing a system for the detection, measurement, and communication of a value of one or more physiological property of a person, or other living organism, and includes a sensor assembly structured to detect, measure, and communicate at least one value during a monitoring period. The sensor assembly may include an array of interchangeable sensors structured to detect, measure, and communicate such values during the monitoring period. The value or values of the physiological property or properties may be communicated to a central processing unit via a communication interface wherein the value(s) are analyzed to generate an activation signal structured to affect operation of an integrated component. Alternatively, the value or values may be communicated to one or more third party, such as a physician, psychologist, security personnel, friend, family member, intimate partner, etc., for independent review and analysis. A method is also provided for detecting, measuring, and communicating one or more value, and generating and communicating an activation signal in response thereto.

### SUMMARY OF THE INVENTION

The present invention comprises a real time location and alert system that acts as a silent alarm to pinpoint the source of a potential emergency in a pre-determined area, for example a campus sized facility, such as a school. The system includes a real time location system, monitoring system, such as a heart rate monitor/a call button, and management and escalation protocols. In an illustrative example, a system, method and apparatus in accordance with the present invention is designed to handle a triggering event, such as an armed intruder entering a class room. The teacher within the class room is wearing a monitoring system, preferably a “biosensor” adapted to measure some physiologic change in the user, such as a spike in heart rate. The physiologic change activates the “alarm.” The monitoring system could also include other types of sensors, such as a sound sensor. A camera located in the room is activated based on the biosensor reading. The camera then sends a signal to a remote agency or central processing facility, and plays back a predetermined time period prior to the time of activation. This allows the remote agency to view the triggering event and to notify the emergency personnel, such as law enforcement agents. The camera may be designed to stay on at all times to record the events and provide data and/or to provide on-site visualization for when law enforcement arrives. The biosensor may also include a panic call button that activates the system as well. The system preferably also includes a tactical map display to provide responders with usable information converted from data obtained by the sensors and/or camera in real time, particularly if the intruder is moving.

Accordingly, it is an objective of the present invention to provide an improved security system, devices, and method for monitoring a predetermined area.

It is a further objective of the present invention to provide an improved surveillance system, devices, and method for monitoring a predetermined area.

It is yet another objective of the present invention to provide an improved security and surveillance system, devices, and method for monitoring a predetermined area.

It is a still further objective of the invention to provide an improved security and surveillance system, devices, and method for monitoring a predetermined area using a real time location system.

It is a further objective of the present invention to provide improved security and surveillance system, devices, and method for monitoring a predetermined area using biosensor measurements.

It is yet another objective of the present invention to provide an improved security and surveillance system, devices, and method for monitoring a predetermined area using a combination of biosensor measurements and user activated signaling.

It is a still further objective of the invention to provide an improved security and surveillance system, devices, and method for monitoring a predetermined area which uses data collection to provide an informational tactical map.

It is yet another objective of the present invention to provide an improved security and surveillance system, devices, and method for monitoring a predetermined area which uses data collection to provide an informational tactical map for use by third parties.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a schematic overview of the interrelationship of the main components of the present invention;

FIG. 2 is a schematic representation of the major components of the security system in accordance with the present invention;

FIG. 3 illustrates an example of a map of a predetermined area covered by the security system in accordance with the present invention;

FIG. 4 is a representation of a classroom having one or more data collecting devices or systems therein;

FIG. 5 shows an illustrative embodiment of a biosensor device;

FIG. 6 is a block diagram illustrating some of the components of the biosensor device;

FIG. 7 is an illustrative embodiment of a tactical map;

FIG. 8 is an illustrative example of an incident timeline showing an example of detectable events which create an emergency event generation;

FIG. 9 is a flow chart illustrating the interconnection of several components of the present invention;

FIG. 10 is a flow chart illustrating the interconnection of additional components of the present invention;

FIG. 11 is a Venn Diagram showing the relationship between a detectable event and selected events which generate a detectable event;

FIG. 12A is a flow chart of an illustrative embodiment of a method in accordance with the present invention;

FIG. 12B is a flow chart of an illustrative embodiment of a method in accordance with the present invention.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

The present invention provides a system, methods, and apparatus having the necessary hardware, including detecting devices, computer systems, communication systems, wired and/or wireless connections, and the necessary software to provide for surveillance, security, alerting, and tracking functionality. As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may be comprised of various means including entirely of hardware, entirely of software (including firmware, resident software, micro-code, etc.), or any combination of hardware and software. Furthermore, embodiments of the present invention may take the form of a computer program product including a computer-readable storage medium having computer-readable program instructions (e.g., computer software) embodied in the storage medium, e.g., memory device.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

The one or more computer-executable program code stored in a transitory and/or non-transitory computer-readable medium (e.g., a memory, etc.) directs, instructs, and/or causes a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

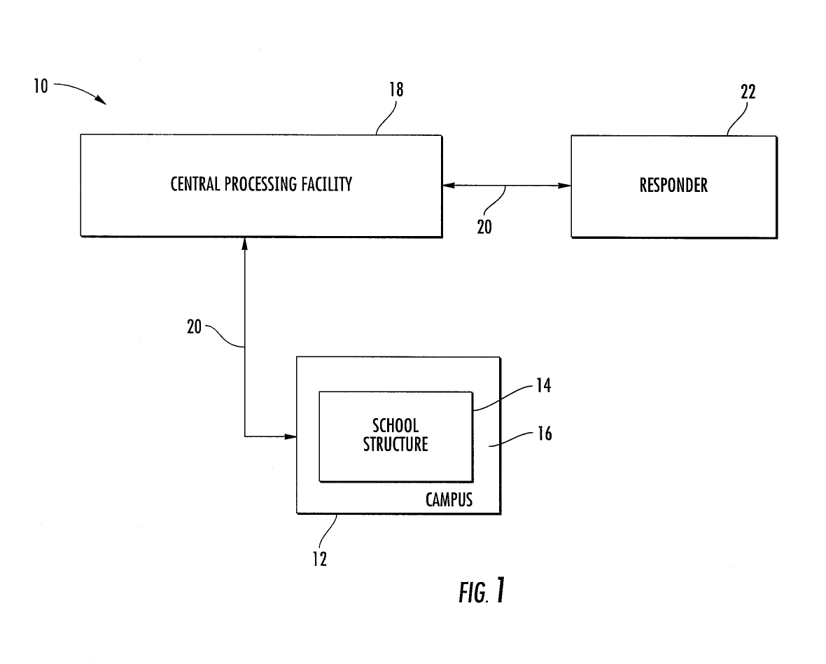

FIG. 1 provides a generalized, schematic overview of the interrelationship of the main components of the present invention. The system, referred to generally as security system 10, is designed to provide a mechanism to prevent an emergency event, i.e. any occurring event within or near the predetermined area that requires assistance of law enforcement or emergency personnel, or if such actions occur, mechanisms to terminate the emergency event with the least amount of harm to individuals present. As such, the use of emergency events includes events that place individuals in danger, including attacks using weapons designed to hurt or kill individuals, such as, but not limited to, using weapons such as firearms or guns, knives, explosion devices, chemicals, or other devices that are designed to inflict death or harm to individuals or structures.

Each security system 10 is designed to provide surveillance of a pre-determined area 12, illustrated herein as a campus area such as a school, including the interior areas of the school's structure(s) 14 and external property 16, such as playground areas or sports facilitates. While the reference to the predetermined area will be illustrated as a school, such reference is not intended to be limiting as the present invention can be adapted to other public or private areas or properties such as neighborhoods, shopping malls, banks, high rise buildings, sports/entertainment arenas, private business that have one or pluralities of structures within a property, government properties, city blocks, as well as schools of varying size, such as elementary schools, high schools, or colleges campuses. The system further includes a security central processing facility 18 which is preferably located at a site that is independent of, or off site from the predetermined area 12. While it is preferred that the security central processing facility 18 is located off site to allow for an independent monitoring, information gathering, and decision making component, the security central processing facility 18 may be located on site of the predetermined area 12.

The pre-determined area 12 and the security central processing facility 18 are linked through communication system(s) 20 to provide bidirectional sharing of information, i.e. information obtained from the predetermined area 12 and sent to central processing facility 18, as well as information obtained from central processing facility 18 and sent to the predetermined area 12. Information obtained by the central processing facility 18 can be processed and used to make decisions, including notifying and providing relevant information regarding the emergency event to third parties 22, such as rescue responders such as law enforcement agencies, fire or other emergency personnel.

Generally, the security system 10 is designed to transmit information relating to an emergency event occurrence, i.e. shooting or takeover of an area by intruders, to provide the emergency responders 22 with information to respond as quickly and as efficiently as possible, thereby minimizing injury to individuals and destruction of property. Preferably, the communication system 20 between the predetermined area 12 and the security central processing facility 18, or any other types of communication between subunits within the system, is through wireless communication systems which can include services provided by known commercial providers using interfaces such as Cellular Digital Packet Data (CDPD), Global System for Mobile Communications (GSM) Digital, Code Division Multiple Access (CDMA), Long Term Evolution (LTE) technologies, and digital data transmission protocols associated with any of the G-cellular telephone standards (e.g. 3G or 4G), Time Division Multiple Access (TDMA) technologies, Evolution Data Optimized Protocol (EVDO) (such as 1xEVDO), radio frequency (RF) signaling technologies, radio transmission technologies (e.g., One Times Radio Transmission Technology (1xRTT)), Transmission Control Protocol (TCP), Internet Protocol (IP), Session Initiation Protocol (SIP), File transfer Protocol (FTP), Real-Time Transport Protocol (“RTP”), User Datagram Protocol (UDP), in-band and out-of-band signaling technologies, and other suitable wireless communications technologies, or any combination or sub-combination thereof, CDPD in combination with a user datagram protocol (UDP) with Internet protocol (IP) as the transmission protocol, although other protocols may be used, such as transmission control protocol (TCP).

The communication system 20 may utilize wired communication individually or, more preferably in combination with wireless technology so that communication system 20 can transmit data to a wired communication network, such as the Internet, with which the security central processing facility 18 is in communication.

Accordingly, the security system 10 is adapted for transmitting event data, video and/or image monitoring information, audio signals and other Network appliance sensor and detector data over significant distances to the security central processing facility 18, or other components of the system, using digital data transmission over networks such as a local area network (LAN), a wireless LAN (WLAN), a wide area network (WAN) such as the Internet for other network automatic assessment and response including dispatch of response personnel. GPS and other geo-location technology can be used to locate, alert and dispatch personnel as well as to indicate the location of one or more events. Automatic mapping, dispatch and response vectoring permits rapid response. The wireless LAN connectivity permits local distribution of audio, video and image data with relatively high bandwidth without requirement of a license, and without relying on a common carrier and the fees associated therewith. The surveillance system may be interfaced with a WAN (wide area network) such as frame relay or the Internet for providing a worldwide, low cost surveillance system with virtually unlimited geographic application. The security central processing facility 18 will have access to all of the surveillance data from the predetermined area 12 via the network or the WAN. A server within the security central processing facility 18 may be used to provide a centralized location for data collection, alarm detection and processing, access control, auto response generation, paging, automatic e-mail generation, telephone dialing and message transmission, dispatch processing, logging functions, configuration management, and/or other specialized functions.

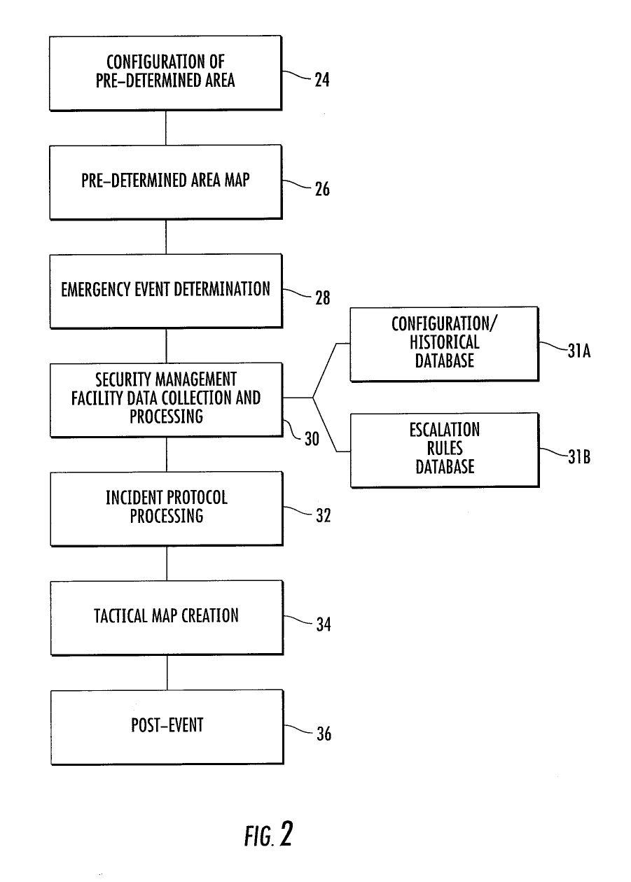

Referring to FIG. 2, a schematic representation of the major components of the security system 10 is shown. The predetermined area 12, security central processing facility 18, and emergency responders 22 interact through the following systems of configuration: configuration of pre-determined area 24, deployment of pre-determined area map 26, emergency event determination 28, central processing facility data collection and processing 30, including creation and use of databases such as configuration/historical database 31A and escalation rules database 31B, incident protocol processing 32, tactical map creation 34, and post event processing 36. In each of the components, various devices and computer hardware and software may be implemented. As described previously, the predetermined area 12 will be illustrated as an elementary school for illustrative purposes only. As such, the security system 10 will be described to prevent or handle an invasion of school property by an individual or individuals having firearms and wanting to injure or kill students, teachers, or administrators located within the school.

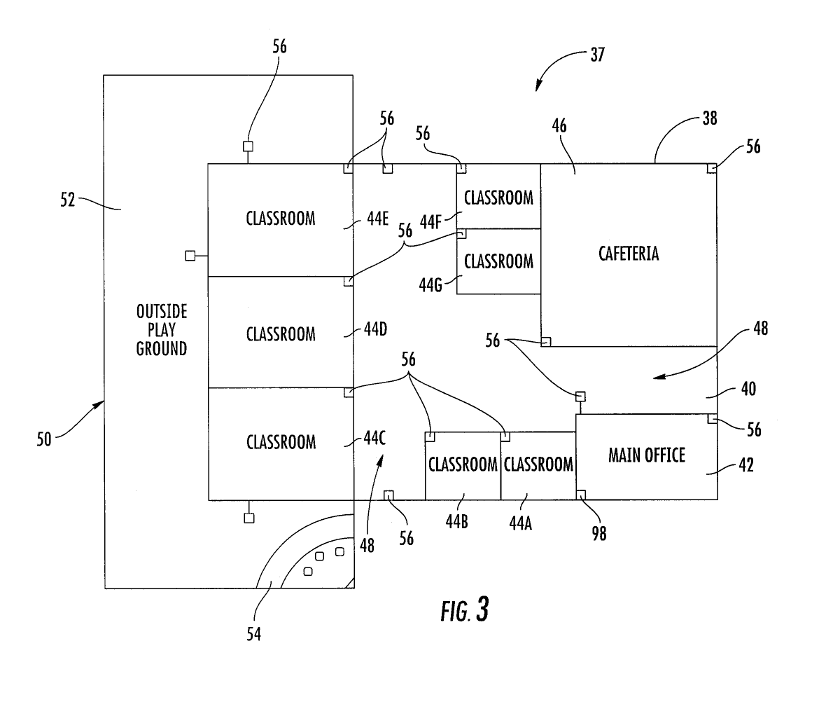

Referring to FIG. 3, a map 37 of a school 38 that has been configured with components of the security system 10 is illustrated. The map 37 generated may be produced in any form known to one of skill in the art, including but not limited to a static, two dimensional representation of the school, a blue print of the school interior identifying room numbers, locations and positions relative to other areas of the school, or a three-dimensional representation, including land topography. In any configuration, the map includes visual representations of one or more components of the predetermined area, i.e. school and/or location information or placement of the data gathering devices and sensors. The school 38 contains an interior portion 40 having, for example, a main office 42 for housing the administrators and other staff, a plurality of classrooms, referred to generally as 44, or individually as 44A, 44B, 44C, 44D, 44e, 44F, and 44G, a cafeteria 46, and passageways, or hallways 48. The school 38 also contains an exterior portion 50 having, for example, a playground area 52 and a sports field, illustrated herein as a baseball diamond 54.

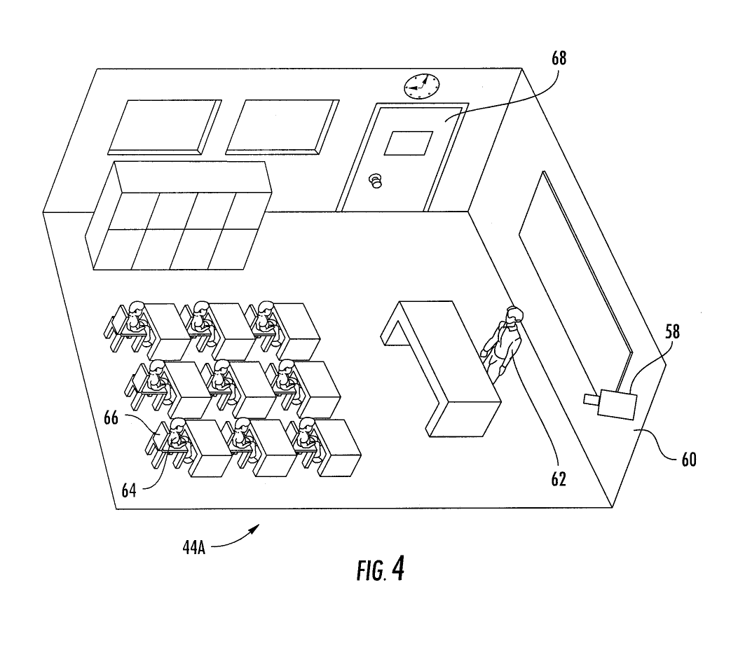

Each area described above is fitted with a data collecting device 56. In a preferred embodiment, the data collecting device 56 is a camera 58 mounted to a classroom wall of classroom 44A, see FIG. 4. Location of the data collecting device 56 is preferably mapped as well. Camera 58 may be a megapixel digital camera having full motion surveillance such as those used for CCTV security systems, with a network, including network components such as wiring, workstations, servers, components to digitize analog signals, components to record segments and storage facility to retain segments of the recorded data. The camera 58 uses any standard camera technology including charge coupled device (CCD) technology, complementary metal oxide semiconductor (CMOS) technology, or other technology known to one of skill in the art for capturing images. The camera 58 may also be adapted to include optical or electro-optical systems to detect the physical phenomenon of the muzzle flash of a bullet being fired or the heat caused by the friction of the bullet as it moves through the air.

As illustrated by the classroom 44A in FIG. 4, a teacher 62 teaching his/her children 64 sitting in their seats 66 are unaware of the threat of an intruder inside the school, particularly if the intruder/gunman is known to school officials and not seen as a threat or enters a campus unknowingly. Once the intruder/gunman enters the classroom door 68, the children and the teacher are at the mercy of the intruder/gunman and have no way of providing an efficient mechanism to alert administrators or more importantly, law enforcement officials. While many students have cell phones, most schools have rules prohibiting their use in the classroom. Moreover, given the fact that an intruder in the class is a surprise, reliance on students for quickly and efficiently notifying law enforcement can be problematic and therefore not reliable. More importantly, any student, or even the teacher, observed using their phone risks being the target of the intruder/gunman. The security system 10 overcomes the notification shortcomings by providing a mechanism that acts similar to a silent alarm commonly used in banks during bank robberies.

In addition to the camera 58, other data collecting devices 56 may be included to enhance the amount and/or type of data collected. Having a variety of devices helps provide a better assessment as to a possible emergency event occurrence. Each area, whether classroom 44 or cafeteria 46 may include sound sensors to detect gun shots or explosions, sensors to detect air quality for indication of the use of chemical or biological weapons, motion detectors, door lock detectors, and detectors to detect camera tampering such as cameras that have been redirected, de-focused, blocked, spray-painted or covered.

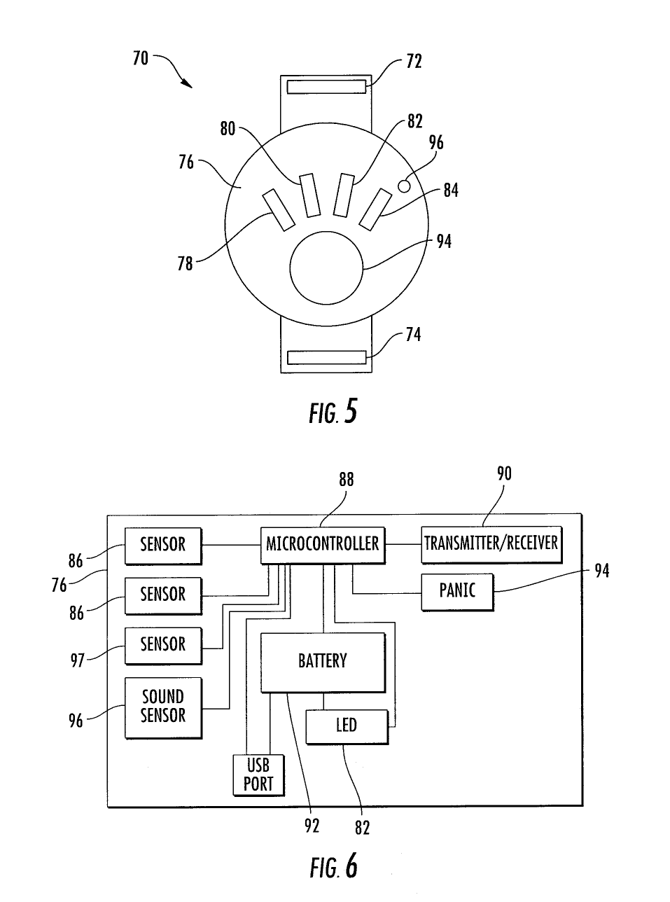

The silent alarm in this case relies, in part, on a sensor carried or worn by school officials, staff, or teachers which is adapted to sense one or more physiological characteristics of the user. Referring to FIG. 5, an illustrative biosensor device 70 is shown. The biosensor device is preferably designed to couple to the individual. As shown, the biosensor device 70 contains wristband loops 72 and 74 for attachment of a wristband (not shown). The outer face 76 contains one or more indicators 78, 80, and 82 for providing visual information to the user. For example, the indicators 78, 80, and 82 may be colored lights, such as LED lights. Indicator 78 may be a power indicator, with green indicating full battery power and yellow indicating low battery strength. Indicator 80 may be used to indicate or alert the individual that a possible emergency event has occurred in another location within the school. In this case, indicator 80 may turn red to indicate a confirmed alert, and a flashing red light indicates escalation of the alert danger to a state of evacuation. Indicator 82 may be used as a privacy mode indicator where, when a blue color is illuminated, privacy has been requested outside the wearer's assigned zone. The blue light shows that the privacy has been enabled. Re-entering an assigned zone will automatically toggle the privacy off. A toggle button 84 may be used to turn the privacy indicator on/off.

The internal components of the biosensor device 70 are designed to provide the capability to detect changes in one or more physiological characteristics of the individual resulting from his/her reaction to an intruder holding, for example, a gun. The biosensor device 70 contains one or more sensors 86 adapted to monitor heart rate, body temperature, blood pressure, blood flow rate, respiratory rate, thermoregulation, including heat loss, or changes in sweat pH, brain activity, or muscle activity. As such, sensor 86A may include, for example, a sensor assembly comprising an oxygen detector or oximeter, structured to monitor the individual's blood oxygen level, and an electrocardiograph detector structured to monitor the individual's cardiovascular activity during the baseline and activity monitoring periods, a respiration rate detector, an electromyograph detector, structured to monitor frequency of muscular contractions of the individual. Because the biosensor device 70 is not designed to specifically monitor the individual vital statistics, a microcontroller 88 having instructions stored thereon and one or more processors for implementing instructions is used. Since not every change in a person's physical parameters is a result of an emergency event, the microcontroller 88 must be able to receive data from the sensor and interpret when such changes are a result of the emergency event. A transceiver (unit containing both a receiver and a transmitter) or transmitter-receiver 90 takes the information processed from the processor and transmits the information to either a central computer system with a server on site and/or to the central processing facility 18 where it can further be processed. Transmission of data is preferably through wireless communication technology. Preferably, the biosensor device 70 is powered by a rechargeable or non-rechargeable battery 92, such as for example a lithium/lithium-ion battery. The device 70 may further include a USB port or plug 93 for connection, communication and power supply with other electronic devices or power sources. The biosensor 70 can be integrated to the campus network to permit or deny access based on usage. For example, a teacher's smart board will not boot unless the teacher is wearing the device.

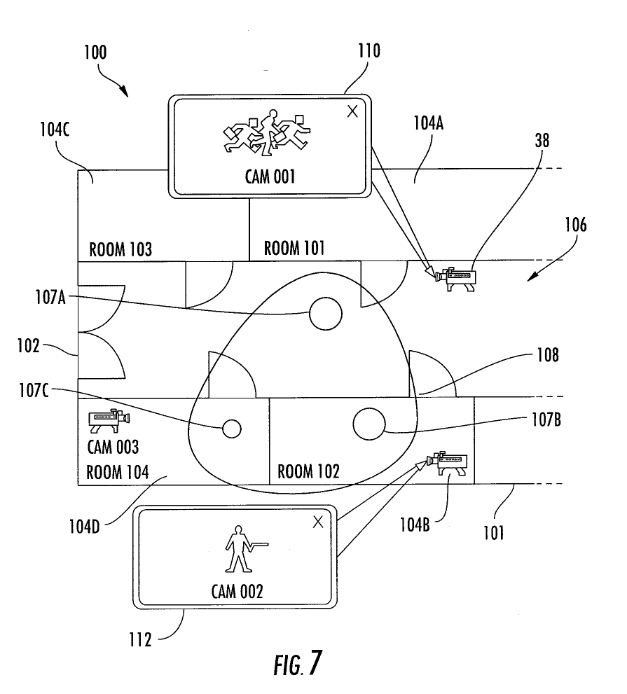

While the main trigger for an emergency event is monitoring and interpreting the physiological changes in an individual, the biosensor device 70 can be adapted to include a trigger alert or panic button. To accomplish such function, the biosensor device 70 may further include an alarm button 94. Should an individual activate this button, an alarm signal is generated to a third party, preferably to the central processing facility 18. Finally, the biosensor device 70 may be adapted to include a third mechanism to determine an emergency event which uses sound detection. The biosensor device 70 may include an acoustic to electric transducer or sensor that converts sound to electrical signal such as a microphone 96. Although not shown, the biosensor device 70 may also be adapted to include optical or electro-optical systems to detect the physical phenomenon of the muzzle flash of a bullet being fired or the heat caused by the friction of the bullet as it moves through the air. In addition, biosensor device 70 may be adapted to detect other important detectable characteristics of the user which are useful for detecting an emergency event, such as via the use of one or more additional detection devices, referred to generally as detector 97 on FIG. 6. The detector 97 may be, for example, some form of microelectromechanical systems (MEMS) technology, including MEMS structures, MEMS sensors, MEMS actuators, MEMS microelectronics, or combinations thereof. Such detectable characteristics may include motion sensing of the user, the ability to measure the user's orientation, and include, but not be limited to, the use of a gyroscope, such as a MEMS microscopic vibrating structure gyroscope integrated on a chip, an accelerometer (MEMS technology, integrated on a chip), a barometer, or combinations of two or more detection devices.

As illustrated in FIG. 3, the map 37 is designed to include geographical information, such as building structures, the internal layout of the building structures, as well as location of cameras 58 and biosensor devices 70. The layout represented in FIG. 3 could be used as the campus map for a specific school. Accordingly, each school would have a different campus map generated. In addition to the location of structures and equipment, the map 37 can further be configured to provide real time location for various individuals, i.e. the teacher, staff, or school administrators. As an illustrated example, the security system 10 can utilize Wi-Fi based tracking systems in which each individual carries a Wi-Fi tag (battery powered if used separately, or preferably as a part of the biosensor 70), or other devices, such as Wi-Fi enabled smart phones or tablets, associated with each individual in need of tracking including existing Wi-Fi networks, such as from Cisco, Aruba, Meru, or Motorola. Additional tracking devices could include the necessary components for GPS tracking or tracking using Radio-frequency identification (RFID) technology. Using for example, specialized software, the locations and data obtained by the tracking of the individuals can be converted into information that can be displayed on the map 37. The information can be displayed on the map as text data, as visual images, icons, or as a heat map. Any real time location data can be used in the determination of whether or not an event (raw data) becomes a triggering event and initiates an emergency response and/or action from the central processing facility 18.

Any data obtained by the biosensor detection and/or activating detection can be processed on site of the school 38 through the individual devices or through an on-site communications module 98, see FIG. 1. The site communications module 98 may contain computer hardware, such as a systems unit including a microprocessor or central processing unit (CPU), memory or random access memory (RAM), graphic user interfaces (GUI), display devices such as monitors, input devices such as keyboards, or servers to process such data. Such computer system may also include software having escalation protocols which include sets of rules which determine whether or not an event is considered an emergency event. Preferably, all raw data captured within the school system is stored within the on-site communications module 98 in order to eliminate large amounts of data being sent to the central processing facility 18. When a trigger event initiates an emergency event, the necessary data can be transmitted to the central processing facility 18 for further processing. Such data can be transferred from the on-site communications module 98, or from the individual data capturing device(s) directly, either one of which can be linked using wireless technology to the central processing facility 18. If needed, the central processing facility 18 can retrieve information stored on the on-site communications module 98 databases. Any data, whether raw data or processed data, therefore can be sent directly to the central processing facility 18 for processing or confirmation using computer systems described above (for example, hardware, such as a systems unit including a microprocessor or central processing unit (CPU), memory or random access memory (RAM), graphic user interfaces (GUI), display devices such as monitors, input devices such as keyboards, or servers to process such data) or any wireless, internet or cloud based systems known to one of skill in the art. If for some reason data cannot be transferred to the processing facility 18, on-site communications module 98 may be configured to send a signal requesting assistance to a emergency agency or a 911 emergency call center.

The central processing facility 18 is further adapted to provide conversion of data into usable information through software programs which convert the campus map into a tactical heat map. Individuals within the central processing facility 18 can be used to view events as displayed on the cameras, thereby providing one or more human confirmation steps. Referring to FIG. 7, a tactical heat map, referred to generally as 100, of a campus 101 is illustrated. The campus 101 is similar to the school structure 38 and includes an entrance 102 to the school and a plurality of rooms 104A (indicated as room 101), 104B (indicated as room 102), 104C (indicated as room 103), and 104D (indicated as room 104). The campus 100 contains a plurality of cameras in various positions, i.e. in rooms, see room 102 and within the hallways 106, outside of room 101. The tactical heat map 100 is designed to provide location information as the intruder/gunman moves about the area.

The tactical heat map 100 integrates several features to provide a more accurate real time assessment which can be used by responders to assess the situation and to provide a plan to end the situation as quickly and peacefully as possible. The tactical heat map 100 includes color, size, and shape to convey certainty of data. Color can be used as a certainly indicator in which different shades of color indicates the certainty of the data. For example, colors shown in shades of reds, oranges, and yellows indicate the most certain data information, and lighter colors such as shades of blues are less accurate information. Visual confirmation by the central processing facility 18 can be used to develop the color of the heat map, which may be used to distinguish between data obtained from the sensors. Shape may be used to visualize importance. The larger and more defined a circle (source) is on the heat map, the more relevant or important it is determined to be, see large, most relevant data circle 107A, medium circle 107B, and small, least data relevant circle 107C. Pushing a call button will generate a large and defined circle, whereas a sound sensor in the next room might not. The intruder/gunman, to the extent his position can be identified, will be displayed with its own distinct shape. Intensity can be used to indicate timeliness. As data used ages, i.e. time passes, its intensity on the map fades. As such, the initial positioning of the intruder/gunman will fade as he/she moves away from it.

The shaped region 108 indicates an area of the campus 101 for which data, through for example, video capture or sensor data, regarding the intruder/gunman has been obtained. As described above, color, shape and intensity are utilized to quickly and easily convey certainty, importance, and timeliness. Intensity of colors can also be used to correspond to the timeliness of data points entered. Finally, callout boxes 110 and 112 can be accessed to show video information, such as looped video feeds for cameras nearest the incident. Such features are useful for responders that have the time and need to see video feeds.

Previously described features, as well as new features of the present invention are further described through an illustrative example of a method and apparatus which utilize hardware, software, and other devices to provide a real time location and alert system that acts as a silent alarm to pinpoint the source of a potential emergency in the pre-determined area, for example a campus sized facility, such as a school. The system includes a real time location system, monitoring system, such as a heart rate monitor/a call button, and management and escalation protocols.

One of the requirements associated with security systems, particularly in public places like a school campus, is the need for preventing false alarms. Any system must provide a mechanism to interpret everyday occurrences (raw data) from those that are truly an emergency event requiring action. A typical school day can generate a lot of raw data, as each day can be filled with hundreds or thousands of events. Moreover, because public spaces accommodate many different groups of individuals, what is routine for one group may not be routine for another. Each school room may have different normal occurrences which form its own unique raw data. For example, libraries are typical quiet spaces. Loud noises located in the library may indicate a serious event, whereas loud noises emanating from a room used for music class, physical education, or the cafeteria at lunch time may not. Moreover, each room may be busier at various times of the day, generating different types of sounds or happenings. As such, the campus has different areas that have different historical data, i.e. all occurrences which are unique to that area that occur over a time period. Accumulation and interpretation of the historical data, whether for the entire campus or individual sections, is one critical element in determining true emergency events.

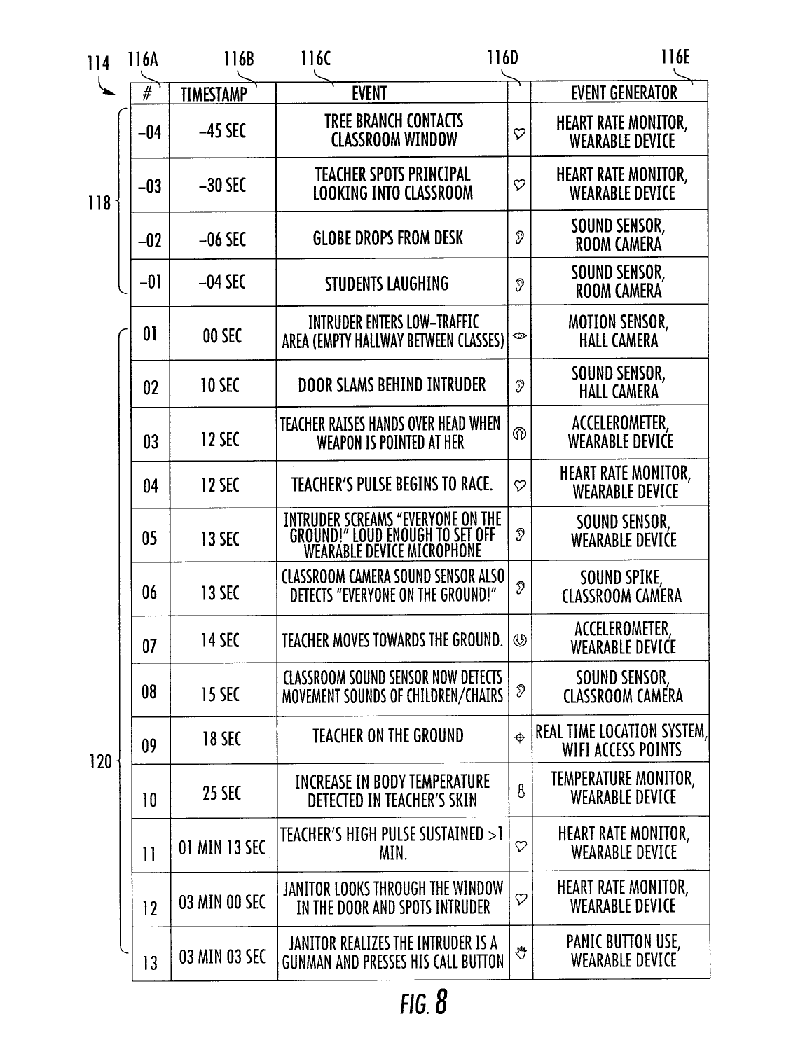

FIG. 8 is an illustrative incident timeline table 114 designed to illustrate the functioning of the various databases, such as configuration/historical databases. The incident timeline table 114 contains a first column 116A indicating a number associated with an event for identification purposes, with (−) indicating those events which occur prior to any event(s) that forms the emergency event. A second column 116B indicates the time of each event 116C that occurs. Each of the events listed in 116C are occurrences that are detected by the detection devices within a day or any time period. Columns 116D and 116E indicate the detection mode, either symbolically (116D) or via text (116E). The events, time and detection methods provide information used to form one or more databases. The databases form an integral part of the security system 10 handling of the large amount of raw data generated each day.

The security system 10 is designed to utilize statistical analysis or modeling using algorithms to combine otherwise innocuous data points into an alarm signal, thereby detecting an emergency quicker than any other methods such as a panic button mounted on a wall. So, a loud noise detected by a sound sensor within the security system 10 might not be an emergency. However, the same event combined with a detected event by the biosensor 70, i.e. changes in heart monitor, could be an emergency. The first four lines, lines (−)01, (−)02, (−)03, and (−)04 indicate the capturing of raw data that would be deemed or used as historical data, 118. Such data includes events that occur on a routine basis which is detectable, i.e. a detectable event, but are not deemed to illicit an emergency response. As described above, each room or area of the school campus could generate its own unique data footprint. In this illustration, various events are detected by biosensor physiological characteristics ( [symbol] ), or other sensors such as accelerometer ( [symbol] ) or temperature ( [symbol] ), location positioning ( [symbol] ), sound sensors ( [symbol] ), or panic button ( [symbol] ). For example a bird flying into a classroom window may startle a teacher and cause a spike in heart rate detected by the biosensor. This event would not generate an emergency response. The other events, a principal observing the teacher and students making or responding to classroom noises may be one of thousands of occurrences per day that are detectable, but must not be treated as an emergency event.

Lines 01-13 illustrate occurrences associated with a gunman getting control of a room before a teacher could press a panic button or call 911 on her personal cell phone. Numerous events occur as a result of this action, each such action being detectable by the security system 10. All these actions would be deemed an emergency event 120 which triggers additional actions. The events 01-13 may not necessarily be significant if occurring in an isolated manner (loud noises are not unusual in a school). Multiple events, however, combined with historical baseline data, rapidly increase the certainty of detecting a violent incident. For instance, Event #03, a teacher raising her hand over her head, is normally innocuous; but in a hostage situation, such an event has a different significance. The security system 10 differentiates itself from other security systems by using a proprietary algorithm to look at the probability of one or more events combining together to become a verifiable incident. Without the present invention, an individual viewing the gunmen in a room, for example the janitor, event #12, would have to dial 911 on his cell phone, this assuming he had even noticed the gunman and assuming he had a personal cell phone on him. With security system 10, other means of alerting the authorities have occurred prior to the janitor, i.e. the video verification procedure would have started minutes earlier. Depending on the historical data for that specific classroom and teacher, the security system 10 would have notified the central processing facility in the range of Event #07 and Event #08. Historical data plays a key role in determining whether an event is atypical and worthy of a greater weight (“severity”) in the statistical analysis.

FIG. 9 is a block diagram illustrating how the databases function within the security system 10 to allow for the system to learn. The learning process begins with the Raw Event Generation 122. Thousands of events, i.e. normal operations of any predetermined area such as a campus or bank building, occur during a time period which is detected by the sensors to create raw events/data generation. This data is collected by servers on-site that contain a set of databases and applications software, referred to together as the “Escalation Protocols” 124 that determine how the raw events should be routed or handled. Data passed to the Escalation Protocols 124 are generally handled in one of three ways. Certain raw events, such as the pressing of a panic button or the automated detection of a firearm shape in a video feed, will immediately escalate to the central processing facility 18 for Alarm Verification 126. Escalation is shown between 124 and 126. In most cases, however, individual raw events are routine and meaningless, and are collected into the Baseline Database 128 which can be used as part of any historical data collection or interpretation, which becomes part of learning about the facilities operations. This is shown as 130, a “rejection” of the escalation. In a third case, a combination of one or more raw events generates an escalation. Individually, the events would not be sufficient to escalate, but when combined, they reach one or more thresholds. The threshold is reached either by an accumulation of event weights or via a probabilistic formula. Because the raw events can be generated by third-party or legacy sensors, the Protocols are operating system and format agnostic, able to accept inputs in formats such as XML.

Once an escalation has occurred, the central processing facility 18 may be responsible for determining the final determination of an incident. If an incident is initiated, then the Incident Protocols 132 are in effect. If, on the other hand, the event or events are rejected for initiating an incident, see 134, they will be posted back to the Baseline Database 128 as having been flagged by central processing facility 18 as rejected. This adds to the knowledge available to the escalation protocols on the routine operations of the facility, adjusting probabilities. In the future, therefore, a similar combination of events might not escalate because the system has “learned.” This learning process most directly involves adjusting the probabilities of various raw events. In the unfortunate circumstance an incident has occurred, a different set of protocols determines how to communicate events to responders such as police. Insofar as data flow is concerned, raw data is now being communicated directly to the central processing facility 18 (and the central processing facility 18 is communicating directly back to the sensors, particularly the camera sensors, as needed).

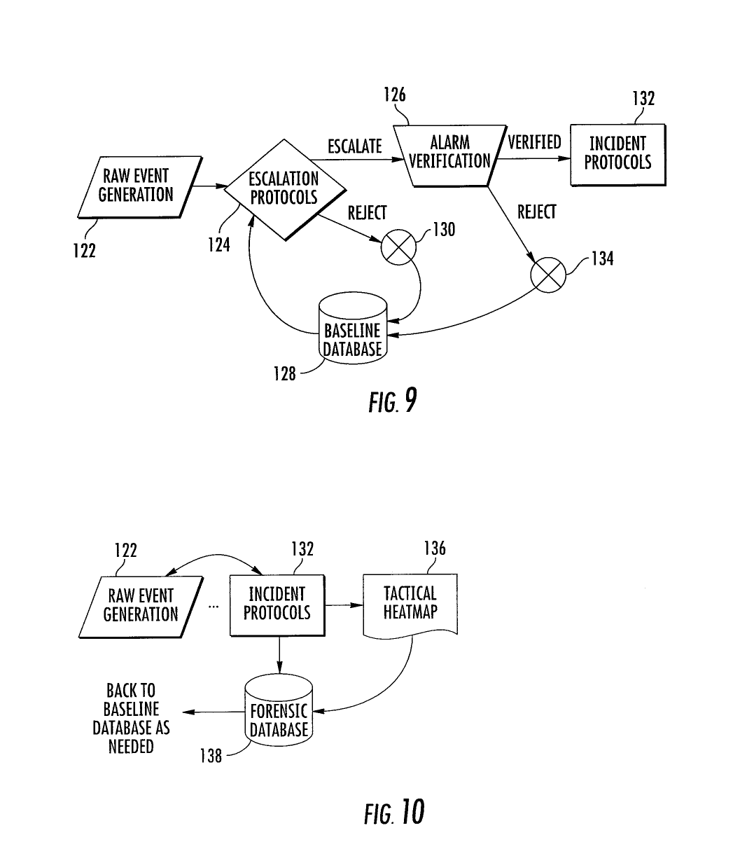

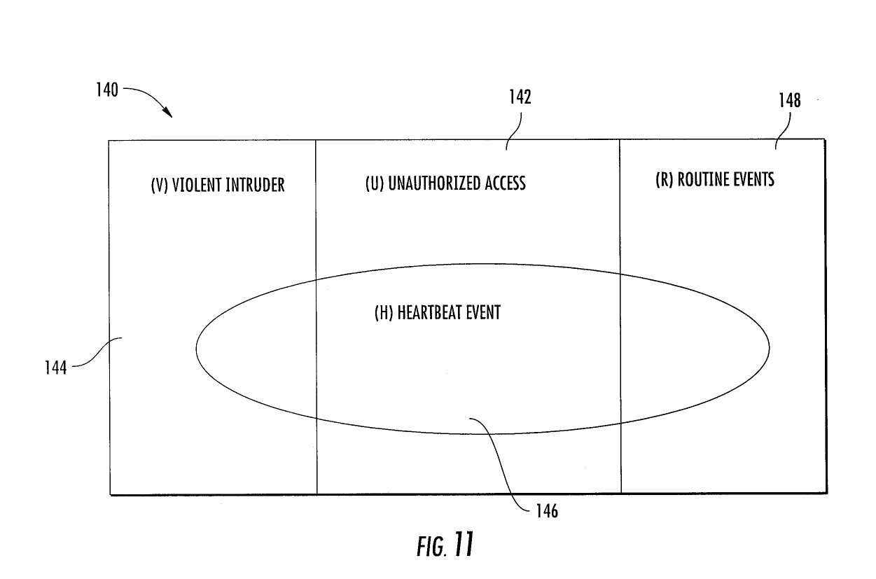

FIG. 10 conceptualizes the direct communication that now exists between raw event generation 122 and incident protocols 132. A Tactical Heat Map 136 is generated by the Incident Protocols 132. The Tactical Heat Map 136 may include human generated inputs based on sensor information. For example, a confirmed second intruder can be marked on the Tactical Map 136 by a workstation operator at the central processing facility 18. The Incident Protocols 132 determines the recipients of the Tactical Heat Map 136 and any other work products based on pre-configured access or distribution lists. Finally, up until the point where a stand down or all-clear signal is given, the information being generated by the incident is all stored in a Forensic Database 138 for later analysis. Any applicable lessons learned may be communicated back to the Baseline Database 128 for future use by the Escalation Protocols 124.

The alarm triggering system can be designed to combine two methods of determining if events are worthy of escalation to the central processing facility 18. The first method uses a threshold; the second method is a probabilistic determination based on historical data. Two systems may be utilized because, when the system is first installed at a facility, no historical data will be available about the normal/baseline operations of the facility. For example, a room such as the music room will be normally noisy. A loud sound in the music room will not carry a high probability of a violent incident, and observations about the behavior of the music room need to be fed into the baseline database. Similarly, an elevated heart rate may indicate a violent incident, but some teachers may routinely have an elevated heart rate for reasons that are not emergency-related (walking up the stairs). Again, information about this sensor must be incorporated over time into the baseline. The two methods, threshold and probabilistic, provide the capability to filter out tens of thousands of false or inconsequential raw events generated by the large number of sensors potentially in use.

The initial system employed is a basic event threshold, wherein each of the raw events is assigned a weight or “severity.” Each event generated, therefore, can be given a weighted number, and/or combinations of certain events can also be given a weighted number. Within a certain time frame, if the sum of the severity of events crosses a certain threshold, an escalation is triggered. Note that some events, in particular the pressing of a panic button, may carry enough weight to result in immediate escalation. Table 1 below shows illustrative examples of severities applied to events generated by the system's various sensors. The threshold for escalation is set by default to >=10. The values assigned in Table 1 are illustrative only.

TABLE 1

| Raw | | | |
|---|---|---|---|
| Event | | | Severity |
| Code | Raw Event Name | System | Value |
| 101 | Change in orientation, | Gyroscope | 1 |
| | to vertical | | |
| 102 | Change in elevation, | Real Time | 3 |
| | to z = 0 | Location System | |
| 103 | Heartbeat to 0 | Heart Monitor | 9 |
| 104 | Heartbeat spike | Heart Monitor | 7 |
| 105 | Elevated heartbeat > 1 | Heart Monitor | 8 |
| | minute | | |
| 106 | Gunshot detected | Microphone | 10 |
| 107 | Glass break | Microphone | 7 |
| 108 | Unspecified loud sound | Microphone | 2 |
| 109 | Video signal loss, | Camera | 3 |
| | single camera | | |
| 110 | Video signal loss, | Camera | 8 |
| | nearby camera | | |
| 111 | Person enters | Camera | 4 |
| | unauthorized area | | |
| 112 | Person enters | Camera | 1 |
| | low-traffic area | | |
| 113 | Button pressed | Panic Button | 10 |

From the sample data above, the detection of either a gunshot sound or the pressing of a panic button will automatically reach the threshold. Note that the central processing facility 18 may still reject the escalation as a non-incident (for example, a child on the playground grabbed a teacher's wrist, accidentally pressing the wearable panic button). In some situations, other events may need to occur in combination to reach the threshold. Raw Event Code #103, the loss of the heartbeat signal is relatively severe, but might still be the result of a teacher momentarily removing their wearable sensor to adjust the wristband. This event, in combination with Raw Event Code #111, a person detected in an unauthorized area, would reach the threshold and begin an escalation. The Event Threshold method has many opportunities for false escalations. As data is gathered, the system can begin to employ more sophisticated methods such as probabilistic analysis.

Probabilistic Analysis. Once adequate baseline data has been accumulated, more sophisticated methods can be incorporated to increase the accuracy of the escalation protocols. One such illustrative method is the use of Bayes' Theorem, also known as Bayes' Rule. Bayes' Rule can be applied in different ways. The formula (Equation I) below shows the rule in its general discrete form:

$$P ( {B}_{k} \vert A ) = \frac{P ( {B}_{k} ) \times P ( A \vert {B}_{i} )}{{\sum }_{i = 1}^{n} P ( {B}_{i} ) \times P ( A \vert {B}_{i} )} , k = 1 , 2 , … , n$$

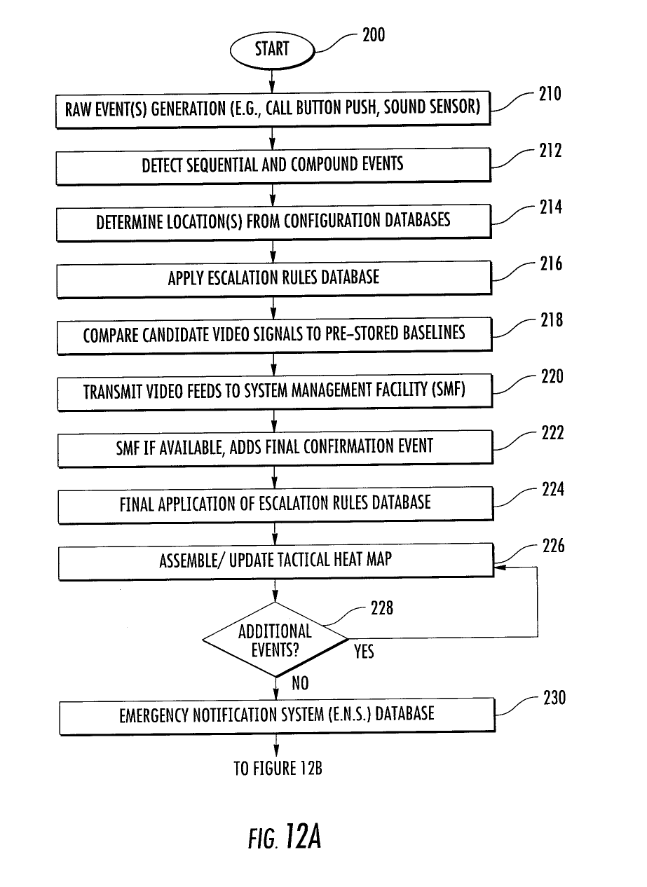

FIG. 11 illustrates a Venn Diagram 140 showing the relationship between a few selected events. For simplicity, only four events are shown, but the system is capable of handling many different events in combination. The Venn diagram models a circumstance where an unauthorized individual has been detected at a certain place or time, shown as (u) and indicated as 142. That individual can be a student wandering the empty halls between classes or a violent intruder (v) indicated as 144. Another event is an elevated heartbeat detected by a wearable sensor, shown as (h) indicated as 146. The elevated heartbeat can be caused by seeing the violent intruder, or it could be caused by something innocuous. Finally, the school facility has many routine events that are shown simply as (r), indicated as 148. Any one of these events, (h), (u) or (r), may indicate the occurrence of a violent incident (v) that requires an escalated response. Bayes' Theorem may be applied to estimate the probability that a violent intruder (v) is present given the occurrence of an elevated heartbeat (h). This probability can be expressed as P(v|h). Equation II:

$$P ( v \vert h ) = \frac{P ( h \vert v ) \times P ( v )}{P ( h \vert v ) \times P ( v ) + P ( h \vert u ) \times P ( u ) + P ( h \vert r ) \times P ( r )}$$

Table 2 below shows initial assumptions of what the probabilities for each of the various events might be. So, for example, the probability of an unauthorized individual in the hallway P(u) is 1 out of 100, or 0.01. The probability of a violent incident, P(v), is 1/10000 and the remaining routine events P(r) happen 9899/10000 times.

TABLE 2
Initial Probability Assumption:

| | |
|---|---|
| $P ( v ) = \frac{1}{10000}$ | $P ( h \vert v ) = \frac{9}{10}$ |
| $P ( u ) = \frac{1}{100}$ | $P ( h \vert u ) = \frac{1}{10}$ |
| $P ( r ) = \frac{9899}{10000}$ | $P ( h \vert r ) = \frac{1}{1000}$ |

Probabilities are also estimated for combined events. So, the probability of an elevated heartbeat given a violent incident P(h|v) might be 9 out of 10. The probability that someone will have an elevated heartbeat if there is an unauthorized individual in a hallway, P(h|u), is estimated at 1/10. Finally, P(h|r), the probability of an elevated heartbeat given routine events is 1/1000.

Plugging the sample data into the formula produces a probability for a violent intruder given an elevated heartbeat, which can be expressed as a percentage (4.4% in this case):

$$P ( v \vert h ) = \frac{0.00009}{0.00009 + 0.001 + 0.0009899} = 0.043721$$

The prior probabilities shown above are estimates for illustrative purposes. Once baseline data for a particular campus is gathered, the probabilities shown may change greatly. For example, P(h|u) for a teacher in a certain classroom might actually be closer to 1/5000. In addition, the formula shown here only contains a few raw event types; the fully implemented system would be calculating the interaction between hundreds of raw event types across potentially hundreds or even thousands of sensors.

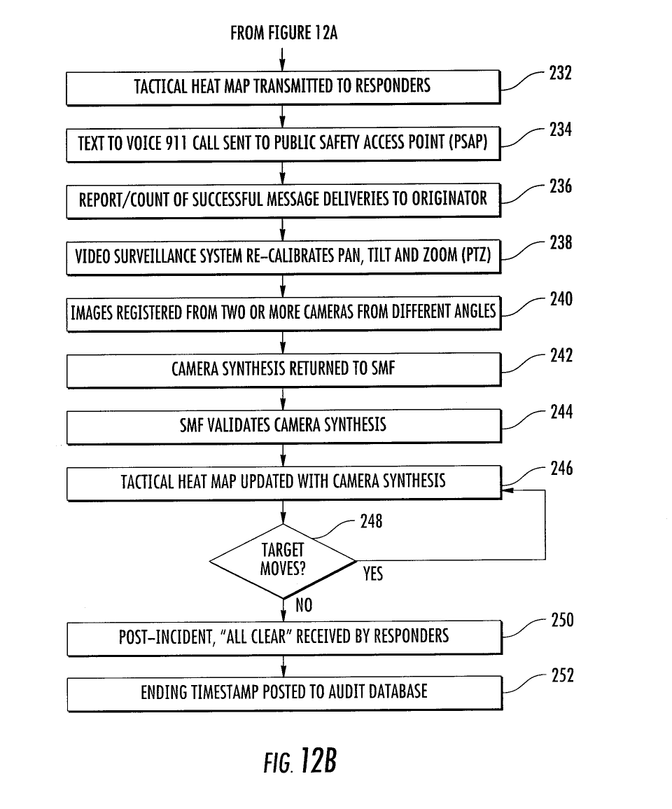

Referring to FIGS. 12A and 12B, an alternative illustrative example of a method in accordance with the present invention is shown. As illustrated at step 200, a triggering event may be the entering of a gunman into a school and attacking a class room. This action triggers the generation of an emergency event, see step 210 by the creation of data as a result of activation and generation of data from the data collection devices, such as a camera or sound sensor inserted within the classroom, a biosensor designed to measure changes of the individual wearing the device, preferably the heart rate of the teacher within the classroom, or combinations thereof. The data collected from the sensors is analyzed to insure that the emergency event is truly an incident which requires the assistance of law enforcement personnel, including detecting sequential and compound events, see step 212, determining locations from configuration/historical databases, see 214, applying escalation rules databases, see steps 216, and a comparison of video or sensor signals to pre-stored baselines, see step 218. The escalation protocols with configuration databases from integral parts of a decision making process which can be used to filter out false positives thereby allowing the system to detect true emergency events, i.e. the mass shooting incidents, and not events that may need attention but are not considered true emergency events. The rules contained in the rules database determine if the events collected in the event queue should be passed along to the central processing facility 18 for final confirmation and for incident management. The primary purpose of the escalation protocols is to prevent the central processing facility 18 from being inundated with false positives.

The increase in heart rate is generated by the teacher viewing and perceiving the danger to children within the class room, as well as his/her own well being. The teacher may be able to generate a physical alarm by pressing the panic button located on the biosensor device attached to his/her body. Once the biosensor is activated, if the camera has not been activated on its own, the biosensor triggers the camera to become activated based on the biosensor reading. The camera then sends a signal to a central processing facility 18, see step 220, and plays back a predetermined time period prior to the time of activation, such as a time period of at least 45 seconds prior to activation. As such, while the camera maybe monitoring and recording its surrounding on a continuous basis, the central processing facility 18 is not viewing a live feed until the generation of the emergency event occurs. Once the event occurs, the area covered by the camera can be viewed continuously until the incident has ceased. Such feature allows for less intrusion to the daily happenings of the teacher and/or student in the classroom.

Prior to moving forward, individuals within the central processing facility 18 can review the video and sensor data and make a visual confirmation of the reason for the triggering event, see step 222. The central processing facility 18 may carry the greatest, and final, weight in the escalation procedure. In essence, if a trained staffer at the central processing facility 18 confirms an incident, it carries a 100% weight. The operators at the central processing facility 18 preferably follow the Incident Protocols to manage the information being sent to the responders, in particular the confirmation of video feeds. In the event that communication is lost with the central processing facility 18, or no response is received within a fixed period of time, a local controller within the school campus is adapted to have its own set of rules to launch an incident response request automatically.

Once the final application of the escalation rules database, see step 224, confirms that the trigger event is indeed an emergency event, the system provides for the creation of the tactical map, see step 226. The tactical map is created from the map of the school system which includes the geographical layout of the structure and surrounding area, as well as the positioning of the sensors and cameras. The tactical map is prepared and updated as warranted by the circumstances, see step 228. The central processing facility 18 continually improves the work product as additional information is received. The production and rendering of the Tactical Map might literally repeat hundreds of times during an incident. The conversion of the campus map to the tactical map involves converting data into information, which is then passed along and securely communicated to the response team and other authorized recipients, i.e. law enforcement and safety personnel, see steps 230 and 232.

Additional information and or steps may be taken by the system, including calls to 911, see step 234, report of successful message delivery, see step 236, recalibration of video cameras, see step 238, enhancement of images such as differing video angle, see step 240. Given the speed at which a situation evolves, the map interface is designed to be simple and intuitive. In addition, the map design balances the need for critical information without overloading the end user with noise. Each responder may have access to the generated tactical maps through the display application, which preferably is multi-platform, able to be seen and manipulated via PC or authorized secure Mobile App. The responder may therefore have such maps downloaded directly to the responder's computer or may have electronic access, for example through the use of a website for which the responder can log in and view the maps.

Additional steps include camera synthesis returned to the central processing facility 18, validation of camera synthesis, tactical heat update with camera synthesis, and determination of whether or not the intruder/gunmen moves, see steps 242-248. Once the intruder/gunman has been captured or killed and the threat therefore has been neutralized, an all clear signal is sent to the responders, see step 250, and recorded, see step 252.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of providing a security and surveillance system for a predetermined area comprising the steps of:
providing at least one data collecting device within a predetermined area; said at least one data collecting device adapted to provide information related to at least one event occurring within said pre-determined area;
providing a map corresponding to a predetermined area, said map including visual representation of one or more components of said predetermined area in combination with the location of said at least one data collecting device positioned within said predetermined area;
obtaining information related to at least one event within said predetermined area; and
determining if said least one event within said predetermined area is an emergency event which requires assistance to one or more individuals within said predetermined area;
providing a tactical map if said at least one event within said predetermined area is determined an emergency event.

2. A method of providing a security and surveillance system for a predetermined area according to claim 1 wherein said at least one data collecting device is a biosensor adapted to measure at least one physiological characteristic of user located within a predetermined area, said biosensor being coupled to said user.

3. A method of providing a security and surveillance system for a predetermined area according to claim 1 further including the step of using real time tracking location to track at least one individual within said wherein predetermined area.

4. A method of providing a security and surveillance system for a predetermined area comprising the steps of:
determining an area to be monitored;
providing at least one data collecting device within said area to be monitored; said data collecting device adapted to provide information related to an occurring event that requires assistance within said area;
providing at least one system for capturing data collected by said one data collecting device
providing at least one biosensor adapted to measure at least one physiological characteristic of a user;
coupling said at least one biosensor to an individual located within said area;
providing at least one system for capturing data collected by said least one biosensor;
providing a map corresponding to said area, said map including visual representation of one or more components of said predetermined area in combination with the location of said at least one data collecting device positioned within said predetermined area;
obtaining information from said at least one biosensor coupled to said individual, said information comprising information related to the physiological reaction of said user to an occurrence within said pre-determined area that requires assistance;
providing said data obtained from said biosensor or at least one data collecting device said to an off-site facility;
determining if said an emergency event has occurred; and
if an emergency event has been determined to have occurred, providing a tactical map.

5. The method of providing a security and surveillance system for a predetermined area according to claim 4 further including the step of notifying a third party that said emergency event has occurred within said predetermined area.

6. The method of providing a security and surveillance system for a predetermined area according to claim 4 further including the step of providing said third party access to said tactical map.

7. The method of providing a security and surveillance system for a predetermined area according to claim 4 further including the step of obtaining additional data from said at least one data collecting device, at least one biosensor, or combinations thereof.

8. The method of providing a security and surveillance system for a predetermined area according to claim 4 wherein said at least one data collecting device is a video camera.

9. The method of providing a security and surveillance system for a predetermined area according to claim 4 wherein said biosensor includes a panic button.

10. The method of providing a security and surveillance system for a predetermined area according to claim 4 wherein said biosensor is adapted to measure the heart rate of said individual.

11. The method of providing a security and surveillance system for a predetermined area according to claim 4 further including the step of updating said tactical map.

12. The method of providing a security and surveillance system for a predetermined area according to claim 4 wherein said data collecting device is a sound sensor adapted to detect gun shots.

13. The method of providing a security and surveillance system for a predetermined area according to claim 4 wherein said data collecting device is a sensor adapted to detect the firing of a firearm.

14. The method of providing a security and surveillance system for a predetermined area according to claim 4 further including the step of determining if an detectable event is an emergency event.

15. The method of providing a security and surveillance system for a predetermined area according to claim 4 further including the step of transmitting said data obtained from said at least one biosensor to a secondary location, said secondary location being located at a different location than said pre-determined area.

16. The method of providing a security and surveillance system for a predetermined area according to claim 4 further including the step of transmitting said data obtained from said at least one data collecting device to a secondary location, said secondary location being located at a different location than said pre-determined area.

17. The method of providing a security and surveillance system for a predetermined area according to claim 4 further including the step of continually collecting data from an emergency event occurrence, and using said continually collected information to update said tactical map.

18. The method of providing a security and surveillance system for a predetermined area according to claim 4 further including the step of providing visual footage of at least one section of said predetermined area prior the generation of said emergency event.

19. A system for providing a security and surveillance for a predetermined area comprising:
a predetermined area for monitoring;
at least one data collecting device within said predetermined area; said data collecting device adapted to provide information related to an occurring event that requires assistance within said pre-determined area;
at least one biosensor adapted to measure at least one physiological characteristic of a user;
at least one system for capturing data; and
a map corresponding to said predetermined area, said map including visual representation of one or more components of said predetermined area in combination with the location of said at least one data collecting device positioned within said predetermined area.

20. The system for providing a security and surveillance for a predetermined area according to claim 19 further including a tactical map.

21. The system for providing a security and surveillance for a predetermined area according to claim 19. wherein said at least one data collecting device is a video camera.

22. The system for providing a security and surveillance for a predetermined area according to claim 19 further including at least one database for determining if one or more events occurring within said predetermined area are emergency events requiring providing assistance to one or more individuals within said predetermined area.

23. The system for providing a security and surveillance for a predetermined area according to claim 22 wherein said data base is a historical events database.

24. The system for providing a security and surveillance for a predetermined area according to claim 22 wherein said data base escalation rules database.
